(19) United States
(12) Patent Application Publication
(10) Pub. No.: US 2018/0242401 A1
(43) Pub. Date: Aug. 23, 2018

(54) HEATING DEVICE FOR A DOMESTIC APPLIANCE

(71) Applicant: BSH Hausgeräte GmbH, Munich (DE)

(72) Inventors: Stefan KOBLER, Tacherting (DE); Robert KÜHN, UNBEKANNT VERZOGEN (DE); Philipp SCHALLER, Traunreut (DE)

(21) Appl. No.: 15/747,173

(22) PCT Filed: Jul. 1, 2016
(86) PCT No.: PCT/EP2016/065536

§ 371 Date: Jan. 24, 2018

(30) Foreign Application Priority Data
Jul. 31, 2015 (DE) 102015214628.6

(51) Int. Cl. H05B 3/26

(52) U.S. Cl. CPC H05B 3/26

(57) ABSTRACT

A heating device for a domestic appliance includes a planar carrier having an electrically-insulating carrier surface. Thermally sprayed onto the carrier surface is an electrically-conductive layer structure, and an electrically-conductive contact volume is applied onto the layer structure. The contact volume is made of conductive glue. In a method for electrically connecting the thermally sprayed layer structure, a volume of a pasty conductive glue is applied to the layer structure, and the conductive glue is allowed to solidify.

The invention relates to a heating device for a domestic appliance comprising a planar carrier with an electrically-insulating carrier surface, at least one electrically-conductive layer structure that is thermally sprayed onto said carrier surface and at least one electrically-conductive contact volume applied onto at least one thermally-sprayed layer structure. The invention also relates to a domestic appliance with such a heating device. The invention further relates to a method for electrically connecting a thermally-sprayed layer structure of a domestic appliance. The invention is in particular advantageously usable on cooking appliances, in particular steam cooking appliances, water-conducting laundry care appliances, dishwashers and small domestic appliances.

For the electrical connection of the thermally-sprayed layer structure with a heating device of the type named in the introduction, solder or soldering paste is used as the contact volume. However, for the majority of solders it is necessary to use a flux to ensure that the solder adheres to the layer structure. The flux can be absorbed by the layer structure, which as a rule is slightly porous. This can have an adverse effect on the connection of the solder to the thermally-sprayed layer structure and the properties of the thermally-sprayed layer structure itself. If, in addition, the layer structure is also applied onto a porous insulation layer, the flux can penetrate the insulation layer and impair the electrical insulation properties.

DE 31 09 250 A1 discloses an electric domestic appliance with casing parts which are made of an electrically-conductive material and are connected to one another in an electrically-conductive manner to provide protective electric grounding. Reliable grounding of the different conductive parts is to be achieved while keeping the outlay on production low. To achieve this, it is proposed that an electrically-conductive adhesive compound be used as an electrically-conductive connection. Preferably, an electrically-conductive glue, for example an organic silicone cement containing powdered metal or carbon as a filler, serves as the adhesive compound. The glue retains a certain degree of elasticity even after it has cured, which prevents breaking of the contact owing to thermal expansion.

DE 39 13 028 A1 discloses a method and an apparatus for producing a conductive connection in an electrical appliance with which at least two contact elements to be connected in an electrically-conductive manner are applied spaced apart from each other on an insulating part. The method and/or the apparatus for producing a conductive connection are characterized by the fact that a multi-axis positioning unit applies a current-conducting paste to the insulating part that connects the contact elements applied to the insulating part to one another. However, no contacting of thermally-sprayed layer structures is addressed here.

DE 42 06 700 A1 discloses contacting of the conducting tracks arranged in parallel next to one another on a carrier with corresponding conducting tracks arranged parallel to one another on a flexible conductor sheet, wherein the mutually assigned conducting tracks of the carrier and conductor sheet are superimposed and connected to one another in a conductive manner. Arranged between the conducting tracks of the carrier and the conductor sheet is a glue consisting of an insulating material containing a plurality of approximately uniformly distributed electrically-conductive grains by means of which the carrier and conductor sheet are connected to one another. In the regions of the conducting tracks to be connected, the conductive grains are positioned with respect to one another and to the conducting tracks and form a conductive connection between the mutually assigned conducting tracks of the carrier and conductor sheet. Once again, no contacting of thermally-sprayed layer structures is addressed here.

DE 10 2013 109 755 A1 discloses a conductive glue comprising at least one type of anisotropic conductive nanomaterial and at least one type of photo-induced polymerizable material. No contacting of layer structures is addressed.

EP 0 681 712 B1 discloses an electro-optic thin-film apparatus with an electrically responsive layer with optical properties, which change on exposure to a current or electrical field applied to the layer; at least one electrode that extends beyond the electrically responsive layer and is able to conduct an electric current to the electrically responsive layer; and an electrical connector arranged along a single edge of the apparatus and configured such that it supplies the electrode with electric current from a power supply, wherein the electrical connector comprises: a flexible insulator having an electrically-conductive portion on at least one surface which is able to establish an electrical contact between the electrode and a power supply, an electrically-conductive glue, which is arranged on the electrically-conductive section of the insulator close to the electrode in order to establish an electrical contact with the electrode, wherein the electrically-conductive glue comprises electrically-conductive particles distributed over an entire adhesion-promoting matrix and a connecting device which is in electrical contact with the electrically-conductive section of the insulator and able to establish an electrical contact with a power supply, wherein at least one portion of the insulator is inserted into a portion of the electrically responsive layer of the apparatus and also configured such that the effective contact zone between the electrically-conductive particles and the electrode is sufficiently large to ensure current transfer while the build-up of heat in the electrode in the region below the electrically-conductive particles is minimized. Herein, once again no contacting of thermally-sprayed layer structures is addressed.

EP 0 963 143 A1 discloses a ceramic substrate with an electrical circuit and a connecting apparatus comprising at least one metal connection, for example in the form of a threaded bolt. The connector or the connecting apparatus are connected to the substrate by compensating means made of a metal that is more deformable than the material of the connector, preferably by means of active solder. The compensating means can be embodied in the form of a ring washer or the like and be made of copper and compensate the stresses on cooling. The active solder is advantageously based on silver and copper and a reactive alloying component, for example titanium or a rare-earth metal. The connecting apparatus can be both a heavy-duty mechanical fastening connection for the substrate carrier and an electrical connector for the circuit.

WO 97/42638 discloses a method for gluing together in an electroconductive and voltage-poor manner sensitive parts, possibly with different coefficients of thermal expansion, which need to be accurately positioned with which the glue is applied, then the curing reaction is photochemically triggered and then the parts to be glued are positioned within 1 second to 15 minutes. An adhesive composition is used which has a single component, is storage-stable at room temperature and is filled with metal particles.

WO 98/44593 discloses an electrical connecting arrangement for connecting a circuit support with conducting tracks of a conducting-track support, wherein the circuit support and the conducting-track support are supported by a base plate, the circuit support and the conducting-track support have a region in which they overlap and, in the overlapping region, the circuit support is connected to the conducting-track support by means of an electrically-conductive glue. WO 98/44593 further discloses a method for electrically connecting a circuit support to conducting tracks of a conducting-track support, wherein the conducting-track support is fixed on a base plate, the conducting-track support is provided on its side facing away from the base plate in a region free of an insulating cover against a conducting track with an electrically-conductive glue and a circuit support is glued to the conducting-track support so that an electrical connection is formed between a conducting track of the conducting-track support and a point of contact on the circuit support.

It is the object of the present invention to overcome the disadvantages of the prior art at least partially and in particular to provide an improved possibility for electrical contacting of a thermally-sprayed layer or layer structure of a domestic appliance.

This object is achieved according to the features of the independent claims. Preferred embodiments can in particular be derived from the dependent claims.

The object is achieved by a heating device for a domestic appliance comprising a planar carrier with an electrically-insulating surface (hereinafter referred to as a “carrier surface” without restricting the generality), at least one electrically-conductive layer structure that is thermally sprayed onto said carrier surface and at least one electrically-conductive contact volume applied onto at least one thermally-sprayed layer structure, wherein at least one contact volume consists of electrically-conductive glue (hereinafter referred to as “conductive glue” without restricting the generality).

The use of conductive glue has the advantage of having good adhesive strength on the thermally-sprayed layer or layer structure particularly on porous layers. Herein, it is possible to dispense with the use of fluxes as used in conventional soldering. In conventional soldering with flux, said flux penetrates the porous thermally-sprayed layers. To avoid an adverse effect of the flux, it has to be laboriously rinsed out with solvent. It is now possible to dispense with this step. Contrary to the case with soldering, it is also possible to dispense with a solder resist.

Furthermore, the precisely adjustable viscoelasticity of the conductive glue results in a high application accuracy. Hence, the conductive glue is also suitable for small contacting surfaces so that even small amounts of adhesive are achievable with positional accuracy and without splashes.

Furthermore, the thixotropy of the adhesive system can be adjusted such that a component is held in position following positioning or placement.

A further advantage of using the conductive glue is its good adhesion also on smooth, non-porous surfaces, for example on compact polished surfaces.

The conductive glue can easily be adjusted such that virtually no adhesive or only a small amount of adhesive penetrates the thermally-sprayed layer structure or another porous substrate so that properties of the substrate, for example insulation properties, are not adversely affected. Furthermore, there is only a small degree of ionic contamination—which helps to prevent corrosion at the point of contact. Penetration of the thermally-sprayed layer structure or another porous substrate by the non-electrically-conductive organic adhesive (which is also referred to as bleeding (resin bleeding)) has no adverse impacts on the electrical properties of the thermally-sprayed layer structure.

Furthermore, cured conductive glue can be embodied as thermally stable to at least 150° C. It has a good mechanical strength and an adapted coefficient of thermal expansion, for example in the case of exposure to changing temperatures. It is also sufficiently resistant to ageing, including at high continuous operating temperatures, for the entire lifetime of the product.

Moreover, conductive glue provides a contact volume with good electrical conductivity (for example at least 1×10⁶ S/m, in particular at least 1.5×10⁶ S/m). This results in low contact resistance between the conductive glue and the thermally-sprayed layer structure. Furthermore, the resulting connection has a low temperature coefficient, wherein in particular there is no significant increase in electrical properties of the conductive glue, such as its resistance over the lifetime of the product.

A conductive glue can in particular be understood to be a glue with a matrix made of viscous, in particular pasty, adhesive (for example resin, in particular epoxy resin) with electrically-conductive particles as filler material. The adhesive can generally comprise one polymer or a plurality of polymers. The filler material can, for example, comprise metal particles such as copper, silver and/or gold particles, but also other electrically-conductive and temperature-resistant materials such as certain carbon variants (for example CNTs). The particles can be powder particles. The conductive glue is high- or medium-viscous for processing and solid in its final state. During the curing process, the conductive adhesive shrinks (chemical volume shrinkage due to crosslinking reaction) so that the electrically-conductive particles touch each other and consequently punctiform, linear and/or planar contacts can form and as a result in turn current trails can form in the conductive glue. Typically, there is no defined melting point, only an adhesive-specific glass transition range.

The adhesive is preferably addition-crosslinking so that, during curing, no chemical decomposition products form and escape/evaporate from the material, as is the case, for example, with silicones, which are referred to as “condensation-crosslinking”. Addition-crosslinking silicone is in particular provided as an addition-crosslinking adhesive.

A planar carrier can, for example, be understood to be a flat carrier or a curved carrier (for example with a tubular shape). The carrier can, in particular, have a plate-like basic shape.

The electrically-insulating carrier surface can be an electrically-insulating layer (for example made of ceramic) applied onto a base body or substrate of the carrier (for example a metal sheet). This layer can also be sprayed on thermally. However, the electrically-insulating carrier surface can also be a surface-treated (for example oxidized) layer region of a base body of the carrier. The electrically-insulating carrier surface can, in particular, have non-negligible porosity. When soldering flux is used, said flux may possibly penetrate the associated pores and possibly reduce the capacity for electrical insulation or result in a breakdown on the application of high voltage (for example of more than 1000 V).

In particular, if the base body itself is electrically insulating and temperature-resistant (up to at least 150° C.), it is possible to dispense with a specially embodied surface layer and the carrier surface then constitutes the non-modified surface of the base body. This can, for example, be the case if the base body is made of ceramic.

A thermally-sprayed layer can be understood to be a layer, which has been produced, for example, by molten-bath spraying, plasma spraying (for example atmospheric, under inert gas or under low pressure), flame spraying (for example powder flame spraying, wire flame spraying or plastic flame spraying), high-velocity flame spraying, detonation spraying, cold-gas spraying, laser spraying or PTWA spraying, in particular sprayed onto the carrier surface.

At least one thermally-sprayed layer or layer structure can, for example, be a metallic layer or layer structure, for example comprising aluminum (Al), bronze, copper (Cu), silver (Ag), tin (Sn) etc., or an alloy thereof. The thermally-sprayed layer can also be a nickel-chromium alloy (NiCr). Moreover, the thermally-sprayed layer can be a ceramic layer, for example an electrically-insulating layer. A surface of the thermally-sprayed layer or layer structure can be oxidized.

The thermally-sprayed layer or layer structure can be at least partially covered by at least one further layer. This at least one further layer can constitute a (“contact”) layer for improved electrical contacting, in particular made of metal, for example a layer of tin, copper, silver and/or gold. In this case, the conductive glue can be applied via the contact layer on the thermally-sprayed layer structure.

A layer structure is in particular understood to be a layer, which, in plan view, has a different shape from the shape of the carrier surface, i.e. a layer that does not cover the entire area of the carrier surface. Instead, in plan view, the layer structure on the carrier or on the carrier surface has its own contour (“outer contour”) extending at least partially on the carrier surface (and not only on its edge). The layer structure can, in particular, be present in the form of at least one elongate conductive trail or track. The conducting track can be wholly or partially rectilinear and/or wholly or partially curved. For example, the conducting track can have a meandering course. However, the conducting track can also, for example, be present in the form of a short strip or a rectangular, round, oval etc. contact field.

A contact volume is in particular understood to be a bulk volume of electrically-conductive contact material, namely here the conductive glue.

In one embodiment, at least one thermally-sprayed layer structure is a resistive heat-conducting layer, in particular a thick layer. The heat-conducting layer can, in particular, be an elongate heat-conducting track. The heat-conducting track can, for example, extend in a meandering or spiral shape. Soldering compound, in particular, can be applied in the region of at least one end of the heat-conducting layer for its electrical connection. The material provided for the heat-conducting layer can, in particular, be aluminum, an aluminum compound or a nickel-chromium compound. The heat-conducting layer can also in particular constitute a thermally-sprayed panel heater for domestic appliances.

In one development the thermally-sprayed layer structure—in particular also a heat-conducting layer—is connected by means of a trail of conductive glue with a further electrically-conductive region of the heating device. The further electrically-conductive region can, for example, be a further heat-conducting layer or an electrical terminal contact (for example in the form of a thermally-sprayed layer structure or as a metallic contact field). In this development, the conductive glue can, in particular, also partially extend on the carrier surface.

In a further embodiment, the thermally-sprayed layer structure is permeable to soldering (flux) means. Penetration of the layers by soldering flux could have an adverse effect on the electrical properties and corrosion stability of the thermally-sprayed layer structure. However, the conductive components (i.e., the electrically-conductive filler) of the conductive glue are unable to penetrate the thermally-sprayed layer structure thus avoiding any adverse effect on the layer properties. Therefore, the thermally-sprayed layer structure is impermeable to the conductive components of the conductive glue. Furthermore, the thermally-sprayed layer structure can be impermeable or only partially (slightly) permeable to the adhesive.

In a further embodiment, the—possibly also thermally-sprayed—carrier surface is permeable to soldering flux. Penetration of the carrier surface by soldering flux could have an adverse effect on the electrical properties and corrosion stability of the carrier surface. However, the conductive components (i.e., the electrically-conductive filler) of the conductive glue are unable to penetrate the carrier surface thus avoiding any adverse effect on its properties. Therefore, the carrier surface is impermeable to the conductive components of the conductive glue. Furthermore, the carrier surface can be impermeable or only partially (slightly) permeable to the adhesive.

In yet a further embodiment, the conductive glue is a reactive one-component (1-C) conductive glue. This has the advantage of particularly simple handling. The 1-C conductive glue can be premixed by the manufacturer of the adhesive, i.e. in that, for example, resin and a hardener are already mixed in the correct mixing ratio. The curing reaction can be greatly delayed by low-temperature storage. However, it is also possible to use two-component or multi-component conductive glues.

The curing can be performed at room temperature or preferably at a higher temperature (for example in an oven). Higher temperatures accelerate the curing reaction and improve the electrical properties. Curing can optionally be performed by means of a photoinitiator contained in the adhesive. Such adhesives are also known as UV- or light-curing adhesives.

In a further embodiment, at least one contact volume connects two thermally-sprayed layer structures—in particular conducting tracks—and to this end lies on the carrier surface present between the layer structures. For example, it is in particular also possible for two or more electrically separated sections of a line to be connected to one another, for example two or more—for example extending parallel to one another—heat-conducting layers (in particular heat-conducting tracks) to form a common heat conductor or heating element. This can, for example, be used for the subsequent compensation of an electrical resistance of a thermally-sprayed heat conductor in order to ensure a required nominal output from the heating device (“trimming”) and/or to repair defects in thermally-sprayed conducting tracks (for example heat-conducting tracks).

In another embodiment, at least one contact volume connects a thermally-sprayed layer structure to an electrical contact pad of a in particular surface-mountable structural element—also known as a SMD (“surface mounted device”) component. For example, thermally-sprayed layer structures and electrical and/or electronic structural elements can be connected to one another particularly simply and inexpensively. In one development, to this end, a dispenser is used to apply an in particular small volume of conductive glue or “dot of conductive glue” onto the thermally-sprayed layer structure and, before the curing of the conductive glue, the contact surfaces (terminals) of the SMD component are pressed onto the dot of adhesive glue. The conductive glue is, for example, cured in an oven process. Following this, the SMD component is reliably secured on the thermally-sprayed layer or layer structure. The SMD component (with, for example, a size of 0603, 0805 or 1206) can be positioned or placed by means of a vacuum gripper. With this kind of SMD mounting, it is possible to dispense with so-called “underfillers” which are sometimes required with SMD soldering to ensure the SMD component does not change its intended position during the soldering process. Wired components provided for through-hole mounting (THT: “through hole technology”) can also be connected by the conductive glue via their metallic contact with the thermally-sprayed structure.

The SMD component can, for example, be a heat-sensitive resistor (for example a NTC resistor), a fuse, a sensor—for example encapsulated in glass solder—etc.

In another embodiment, two thermally-sprayed conducting tracks are electrically connected to one another by an electrical structural element, wherein contact pads of the structural element are connected to the respective conducting tracks by glue dots of the electrically-conductive glue.

In another embodiment, at least one contact volume of conductive glue covers at least one section of the thermally-sprayed layer structure—in particular a heat-conducting layer—without connecting it electrically to another component of the heating device. In this embodiment, in particular at least one contact volume of conductive glue (also referred to as a “conducting layer”) can be applied to the heat-conducting layer in order locally to reduce an electrical current density in the heat-conducting layer. This in turn enables the avoidance of local excess temperatures (so-called “hot spots”). A conducting layer can, for example, be applied onto power terminals, structurally necessary narrow points in conducting tracks, at corners and/or at reversal points in the heat conductor layout. Herein, the conducting layer or the conductive glue can also lie on the carrier surface.

The object is also achieved by a domestic appliance with at least one heating device as described above. The domestic appliance provides the same advantages as the heating device and can be embodied analogously.

The domestic appliance can, for example, be a cooking appliance or an accessory for a cooking appliance (for example a heatable cooking chamber partition). The cooking appliance can, for example, have a steam cooking function, wherein the heating device is assigned a steam-producing apparatus to evaporate water present in the steam-producing apparatus. The cooking appliance can, for example, be an oven with a steam-cooking function or a dedicated steam cooker. The heating device can then, for example, constitute a base of a water tank.

In the case of a heatable cooking chamber partition, at least one thermally-sprayed layer structure, in particular at least one heat-conducting layer can be present on one side or both sides.

However, the domestic appliance can also be a laundry care appliance. The heating device can then be used, for example, to heat the washing liquor in a washing machine or a washer-dryer. The heating device can also be provided as a process-air heater.

The domestic appliance can furthermore be a dishwasher. The heating device can then, for example, be used to heat the washing liquid. In this case, the heater can be a component in a heating-pump assembly.

The domestic appliance can moreover be an electrically operated small domestic appliance, for example a water boiler, a coffee machine (for example in the form of an espresso machine), a toaster etc.

The heating device can be embodied as a tube (generally: a rotationally symmetrical body), wherein at least one thermally-sprayed heat-conducting layer is present on a wall of the tube of the domestic appliance. The tube can then in particular be used or regarded as a through-flow heater for gas passed therethrough (for example process air) and/or liquid (for example water to be evaporated, washing liquid or washing liquor).

The object is furthermore achieved by a method for electrically connecting a thermally-sprayed layer structure of a domestic appliance with which at least one volume of a pasty electrically-conductive glue is at least applied to at least one thermally-sprayed layer structure and the conductive glue is solidified—in particular cured. The method provides the same advantages as the heating device and/or the domestic appliance and can be embodied analogously.

In one development, the conductive adhesive is applied by means of a dispenser.

The above-described properties, features and advantages of this invention and the manner in which these are achieved will become clearer and more plainly comprehensible in conjunction with the following schematic description of an exemplary embodiment explained in more detail with reference to the drawings.

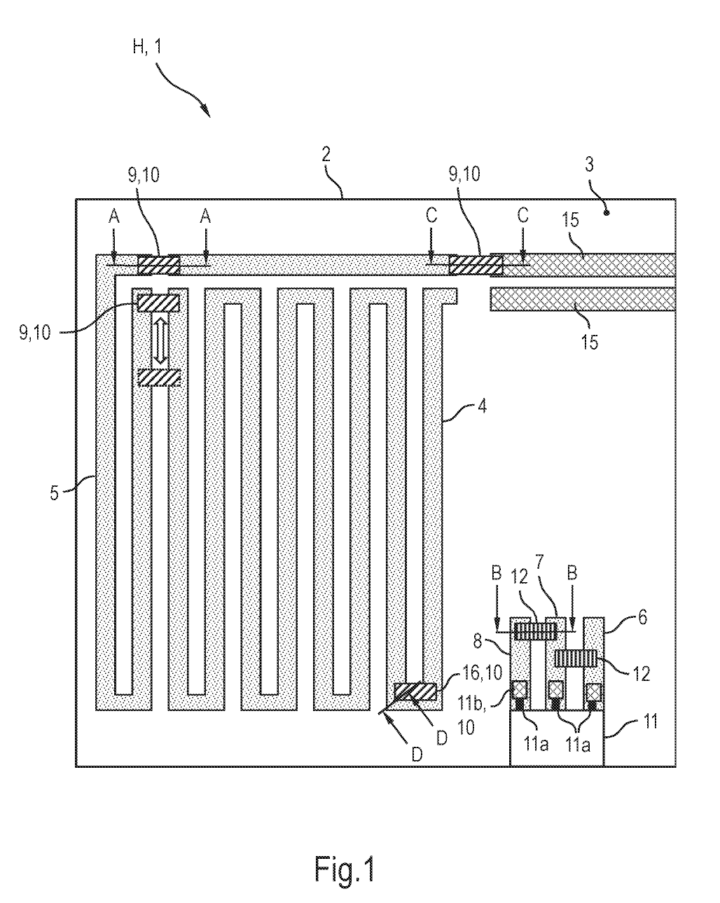

FIG. 1 is a plan view sketch of a heating device of a domestic appliance;

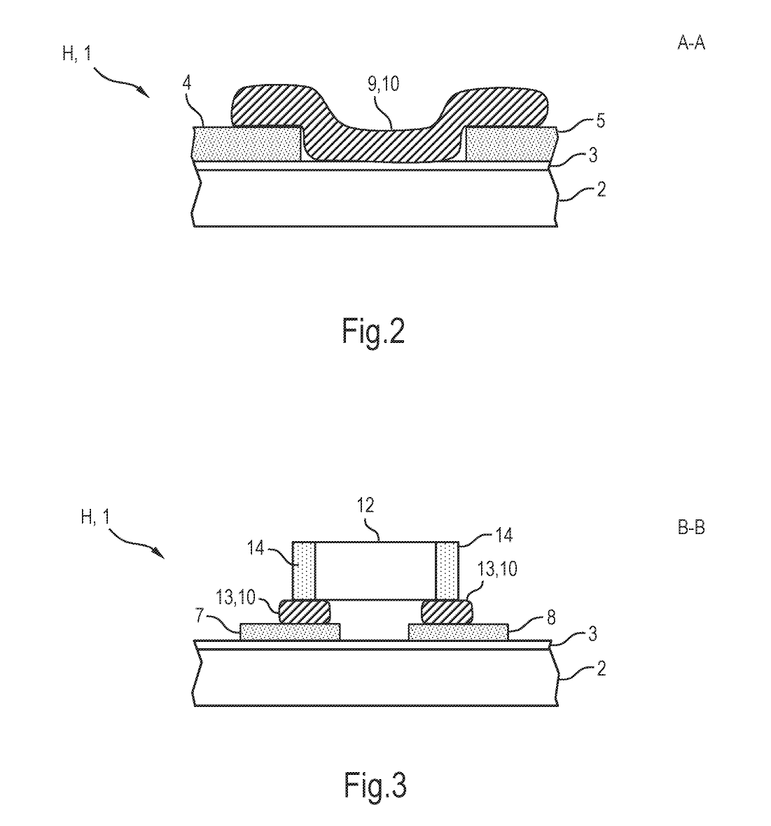

FIG. 2 shows a sectional side view of a first section of the heating device in FIG. 1;

FIG. 3 shows a sectional side view of a second section of the heating device in FIG. 1;

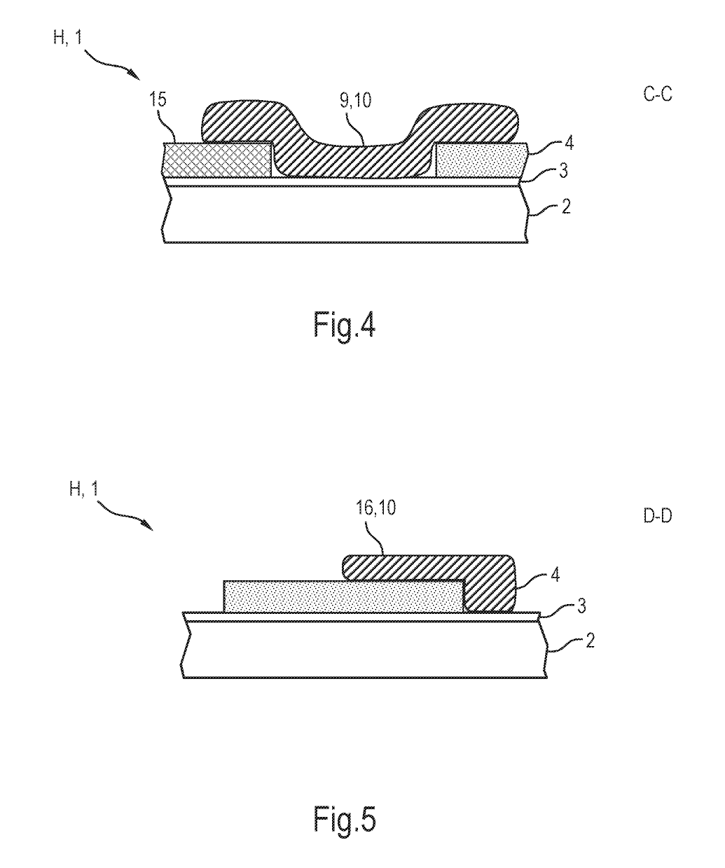

FIG. 4 shows a sectional side view of a third section of the heating device in FIG. 1 and

FIG. 5 shows a sectional side view of a fourth section of the heating device in FIG. 1.

FIG. 1 is a plan view of a heating device 1 of a domestic appliance H. The heating device 1 can, for example, be used to heat water located in a water tank of a steam generator (top diagram). However, the domestic appliance H can also be an oven with steam cooking function, a dedicated steam cooker, an electrically heatable cooking chamber partition, a laundry care appliance, a dishwasher, a small domestic appliance etc.

The heating device 1 comprises a planar carrier 2 (for example made from a metal sheet) with an electrically-insulating carrier surface 3 (for example made from a slightly porous ceramic layer). A plurality of metallic layer structures 4 to 8 are thermally sprayed onto the carrier surface 3. The thermally-sprayed layer structures 4 to 8 are electrically insulated from one another by the carrier surface 3 and comprise: a first (long) meander-shaped heat-conducting layer in the form of an elongate first heat-conducting track 4, a second (short) meander-shaped heat-conducting layer in the form of an elongate second heat-conducting track 5 and three rectilinear conducting tracks 6 to 8.

The two heat-conducting tracks 4 and 5 are electrically connected to one another by two trails 9 of electrically-conductive conductive glue 10. This causes the two heat-conducting tracks 4 and 5 to be electrically connected in series. If the second heat-conducting track 5 is not used, instead of the two trails 9, the two corresponding ends of the first heat-conducting track 4 could be connected directly to one another by a trail of conductive glue 10 (top of diagram).

As indicated by the section A-A in FIG. 2, to this end, the trail 9 of the conductive glue 10 is drawn from the surface of the first heat-conducting track 4 over the carrier surface 3 to the surface of the second heat-conducting track 5. Herein, the adhesive (for example, silicone polymer or epoxy resin) of the conductive glue 10 is so viscous that it does not penetrate the heat-conducting tracks 4 and 5 and the carrier surface 3 or only penetrates them to a negligible degree, while soldering flux would be able to penetrate and as a result could have a local adverse effect on the properties there. Herein, the solder flux could even penetrate the slightly porous heat-conducting tracks 4 and 5 and reach the underlying region of the carrier surface 3.

The trail 9 can, for example, be applied in that a conductive glue 10 in the form of a reactive 1-C conductive glue is applied in the viscous state of the associated adhesive by means of a dispenser and then cured, in particular at a high temperature (for example up to 150° C.), in particular in an oven.

Returning to FIG. 1, the three rectilinear thermally-sprayed conducting tracks 6 to 8 are connected to a plug connector 11 of the heating device 1, in particular to a respective electrical contact 11a of the plug connector 11. The electrical connection can also be provided via a respective contact volume 11b of conductive glue 10.

Adjacent conducting tracks 6 and 7 or 7 and 8 are connected via respective SMD structural elements 12. Here, the SMD structural elements 12 are by way of example NTC resistors. For example, measured values associated with a respective temperature (for example electrical resistance values, voltage values or current values) can be tapped by the plug connector 11. The SMD structural elements 12 are attached by glue dots 13 of conductive glue 10 to the conducting tracks 6 and 7 or 7 and 8, as shown in section B-B of the heating device 1 FIG. 3.

The SMD structural element 12 comprises on its end regions electrical contacts or contact pads 14, which are connected via the adhesive dots 13 to the respective conducting track 7 or 8. Consequently, the two conducting tracks 7 and 8 are electrically connected to one another by the SMD structural element 12 via the adhesive dots 13.

In particular, to attach the SMD structural elements 12 by means of a dispenser (top of diagram), the adhesive dots 13 can first be applied to the thermally-sprayed conducting tracks 7 or 8. Then—before the curing of the conductive glue 10—the SMD structural element 12 can be applied and its contact pads 14 pressed onto the respective adhesive dots 13, for example by means of a vacuum gripper.

Returning once again to FIG. 1, in addition, two metallic contact surfaces 15 are applied to the carrier surface 3 via which the combined heat-conducting track 4 and 5 can be electrically connected at the end, for example to a power supply. FIG. 4 shows a sectional side view of a section C-C of the heating device 1.

The metallic contact surfaces 15 can be connected by means of a respective trail 9 of the conductive glue 10 to a respective end of the first heat-conducting track 4 and, to be precise, similarly to the connection of the two heat-conducting tracks 4 and 5.

Returning once again to FIG. 1, furthermore at a bend in the heat-conducting track 4, a conducting layer 16 of the conductive glue 10 has been applied to the heat-conducting track 4 and optionally to the carrier surface 3 in order to reduce a current density there and hence prevent the formation of so-called “hot spots”, as shown in section D-D in FIG. 5.

Obviously, the present invention is not restricted to the exemplary embodiment shown.

Generally, “a”, “an” etc. can be understood to mean a single one or a plurality, in particular in the sense of “at least one” or “one or more” etc., unless this is explicitly precluded for example by the expression “exactly one”, etc. It is also possible for a numerical definition to include exactly the number specified and a usual tolerance range unless this is explicitly precluded.

### LIST OF REFERENCE CHARACTERS

1 Heating device
2 Carrier
3 Carrier surface
4 First thermally-sprayed heat-conducting track
5 Second thermally-sprayed heat-conducting track
6 Thermally-sprayed conducting track
7 Thermally-sprayed conducting track
8 Thermally-sprayed conducting track
9 Trail
10 Conductive glue
11 Plug connector
11a Electric contact
11b Contact volume
12 SMD structural element
13 Adhesive dot
14 Contact pad
15 Contact surface
16 Conducting layer
H Domestic appliance

1-13. (canceled)

14. A heating device for a domestic appliance, said heating device comprising:
a planar carrier having an electrically-insulating carrier surface,
an electrically-conductive first layer structure that is thermally-sprayed onto the carrier surface, and
an electrically-conductive contact volume applied onto the first layer structure, said contact volume being made of conductive glue.

15. The heating device of claim 14, wherein the first layer structure is a heat-conducting layer.

16. The heating device of claim 14, wherein the first layer structure is permeable to soldering flux.

17. The heating device of claim 14, wherein the carrier surface is permeable to soldering flux.

18. The heating device of claim 14, wherein the conductive glue is a reactive 1-C conductive glue.

19. The heating device of claim 14, further comprising an electrically-conductive second layer structure thermally sprayed onto the carrier surface, said contact volume lying on the carrier surface between the first and second layer structures for connecting the first and second layer structures.

20. The heating device of claim 14, wherein the contact volume connects the layer structure to an electrical contact pad of a surface-mountable structural element.

21. The heating device of claim 19, wherein the first and second layer structures include each a conducting track, and further comprising an electrical structural element connecting the conducting tracks of the first and second layer structures by connecting contact pads of the structural element to the conducting tracks by glue dots of the electrically-conductive glue.

22. The heating device of claim 14, wherein the contact volume covers at least one section of the first layer structure without connecting the first layer structure electrically to another electrically-conductive component of the heating device.

23. A domestic appliance, comprising a heating device, said heating device comprising a planar carrier having an electrically-insulating carrier surface, an electrically-conductive first layer structure that is thermally-sprayed onto the carrier surface, and an electrically-conductive contact volume applied onto the first layer structure, said contact volume being made of conductive glue.

24. The domestic appliance of claim 23, wherein the first layer structure is a heat-conducting layer.

25. The domestic appliance of claim 23, wherein the first layer structure is permeable to soldering flux.

26. The domestic appliance of claim 23, wherein the carrier surface is permeable to soldering flux.

27. The domestic appliance of claim 23, wherein the conductive glue is a reactive 1-C conductive glue.

28. The domestic appliance of claim 23, wherein the heating device includes an electrically-conductive second layer structure thermally sprayed onto the carrier surface, said contact volume lying on the carrier surface between the first and second layer structures for connecting the first and second layer structures.

29. The domestic appliance of claim 23, wherein the contact volume connects the layer structure to an electrical contact pad of a surface-mountable structural element.

30. The domestic appliance of claim 28, wherein the first and second layer structures include each a conducting track, said heating device comprising an electrical structural element connecting the conducting tracks of the first and second layer structures by connecting contact pads of the structural element to the conducting tracks by glue dots of the electrically-conductive glue.

31. The domestic appliance of claim 23, wherein the contact volume covers at least one section of the first layer structure without connecting the first layer structure electrically to another electrically-conductive component of the heating device.

32. The domestic appliance of claim 23, constructed in the form of a cooking appliance or an accessory for a cooking appliance.

33. The domestic appliance of claim 23, constructed in the form of a laundry care appliance or a dishwashing appliance.

34. A method for electrically connecting a thermally-sprayed layer structure of a domestic appliance, said method comprising:
applying a volume of a pasty conductive glue to the thermally-sprayed layer structure, and
allowing the conductive glue to solidify.
